(19) United States
(12) Patent Application Publication
(10) Pub. No.: US 2016/0223880 A1
(43) Pub. Date: Aug. 4, 2016

(54) Electrophoretic Display and Method for Manufacturing the Display

(71) Applicant: Hydis Technologies Co., Ltd., Icheon-si (KR)

(72) Inventor: Ji Hoon Lee, Seoul (KR)

(21) Appl. No.: 14/996,267

(22) Filed: Jan. 15, 2016

(30) Foreign Application Priority Data
Jan. 30, 2015 (KR) 10-2015-0015145

(51) Int. Cl. G02F 1/167; G02F 1/1339

(52) U.S. Cl. CPC G02F 1/167; G02F 1/1339

(57) ABSTRACT

Provided herein is an electrophoretic display and a manufacturing method thereof, the electrophoretic display including a substrate, an FPL on top of the substrate, a PS (Protect Sheet) on top of the FPL, and a sealant applied between the substrate and PS and along an edge of the FPL in order to seal the FPL; wherein, on a top surface of the substrate, an attractive force area having a property of pulling the sealant is formed along the edge of the FPL and a repulsive force area having a property of pushing the sealant is formed outside the attractive force area.

### CROSS-REFERENCE TO RELATED APPLICATION

This application claims the benefit of priority under 35 U.S.C. §119(a) of Korean Patent Application No. 10-2015-0015145, filed on Jan. 30, 2015, in the Korean Intellectual Property Office, the entire disclosure of which is incorporated herein by reference for all purposes.

### BACKGROUND

1. Field

The following description relates to an electrophoretic display and method for manufacturing the display, and more particularly, to an electrophoretic display where no air layer is formed inside the display during the sealing process, and a method for manufacturing the display.

2. Description of Related Art

Electrophoretic display is a display apparatus that is highly flexible and portable with no need for a light source from outside, and is thus expected to be in the spotlight as the next generation display in the years to come.

As illustrated in FIG. 1, such an electrophoretic display has an FPL 20 (Front Plane Laminate) that includes ink capsules, and this FPL 20 is attached on top of a substrate 10.

Furthermore, on top of the FPL, a PS 30 (Protect Sheet) is attached, and a sealant 40 is applied between the PS 30 and the lower substrate 10 in order to shield the FPL from the atmosphere. This is to prevent moisture from permeating the FPL which has moisture permeability that may otherwise lead to corrosion of the FPL.

The FPL and PS are attached on top of the lower substrate in a lamination method, first the FPL and then the PS. Therefore, the sealant is applied after the PS is attached on top of the FPL so that the sealant is not affected by the high temperature and high pressure environment of the laminating process, and also so that the lamination roller is not contaminated by the sealant.

However, it is not an easy task to apply the sealant in the narrow space between the substrate 10 and PS 30, nor to make air inside be extruded out by the applied sealant to prevent any air layer from being created between the sealant and the FPL.

Thus, as illustrated in FIG. 2, sometimes defects occur where an air fails to be extruded out and instead be trapped inside.

For this purpose, a vacuum sealing method was proposed wherein a sealant is applied in a closed loop shape having an exhaust hole so that the air inside may be extruded out through the exhaust hole (Korean Patent Publication no. 10-2012-0026316).

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A purpose of the present disclosure is to resolve the aforementioned problems of the conventional technique, that is, to provide an electrophoretic display wherein no air layer is formed between an FPL and a sealant, and a method for manufacturing the display.

Another purpose of the present disclosure is to provide an electrophoretic display wherein the applied sealant extrudes out any air layer formed inside using a material that has an attractive force of pulling the sealant and a material that has a repulsive force against the sealant, so that the sealant can be closely adhered to the FPL, and a method for manufacturing such a display.

The aforementioned purposes of the present invention and other purposes may all be achieved by the electrophoretic display and the method for manufacturing the display according to the present disclosure.

According to an aspect, there is provided an electrophoretic display including a substrate; an FPL on top of the substrate; a PS (Protect Sheet) on top of the FPL; and a sealant applied between the substrate and PS and along an edge of the FPL in order to seal the FPL; wherein, on a top surface of the substrate, an attractive force area having a property of pulling the sealant is formed along the edge of the FPL, and a repulsive force area having a property of pushing the sealant is formed outside the attractive force area.

In response to the sealant being a hydrophilic sealant, the attractive force area may be a hydrophilic area and the repulsive force area may be a hydrophobic area, and in response to the sealant being a hydrophobic sealant, the attractive force area may be a hydrophobic area and the repulsive force area may be a hydrophilic area.

A hydrophilic material may be applied on the hydrophilic area, and a hydrophobic material may be applied on the hydrophobic area.

A boundary between the attractive force area and repulsive force area may be outside the edge of the PS (Protect Sheet) when seen from the top.

The attractive force area may be further formed under the FPL.

According to another aspect, there is provided a method for manufacturing an electrophoretic display, the method including forming an attractive force area for pulling a sealant and a repulsive force area for pushing the sealant, on a top surface of a substrate; attaching an FPL on top of the substrate; attaching a PS (Protect Sheet) on top of the FPL; and applying the sealant between the substrate and PS (Protect Sheet) along an edge of the PS (Protect Sheet) in order to seal the FPL; wherein the attractive force area is formed outside the FPL on the top surface of the substrate, and the repulsive force area is formed outside the attractive force area on the top surface of the substrate.

In response to the sealant being a hydrophilic sealant, the attractive force area may be formed as a hydrophilic area, and the repulsive force area may be formed as a hydrophobic area; and in response to the sealant being a hydrophobic sealant, the attractive force area may be formed as a hydrophobic area, and the repulsive force area may be formed as a hydrophilic area.

The hydrophilic area may be formed by UV (ultraviolet) treating the substrate.

The hydrophilic area may be formed by applying a hydrophilic material on the top surface of the substrate, and the hydrophobic area may be formed by applying a hydrophobic material on the top surface of the substrate.

The attractive force area and repulsive force area may be formed such that a boundary between the attractive force area and repulsive force area is outside an edge of the PS (Protect Sheet) on the substrate.

The boundary between the attractive force area and repulsive force area may be formed along a motion path of a sealant needle for applying the sealant.

Various aforementioned aspects of the present disclosure have an effect of providing an electrophoretic display wherein a sealant attractive force area and a sealant repulsive force area are formed so that the applied sealant may extrude out any air layer formed inside and then be quickly and closely adhered to the FPL, and a method for manufacturing the display.

Other features and aspects will be apparent from the following detailed description, the drawings, and the claims.

### BRIEF DESCRIPTION OF THE DRAWINGS

FIG. 1 is a view illustrating a conventional method for applying a sealant in order to manufacture an electrophoretic display;

FIG. 2 is a view illustrating air layers formed between an FPL and sealant in the case where the sealant is applied in the conventional method of FIG. 1;

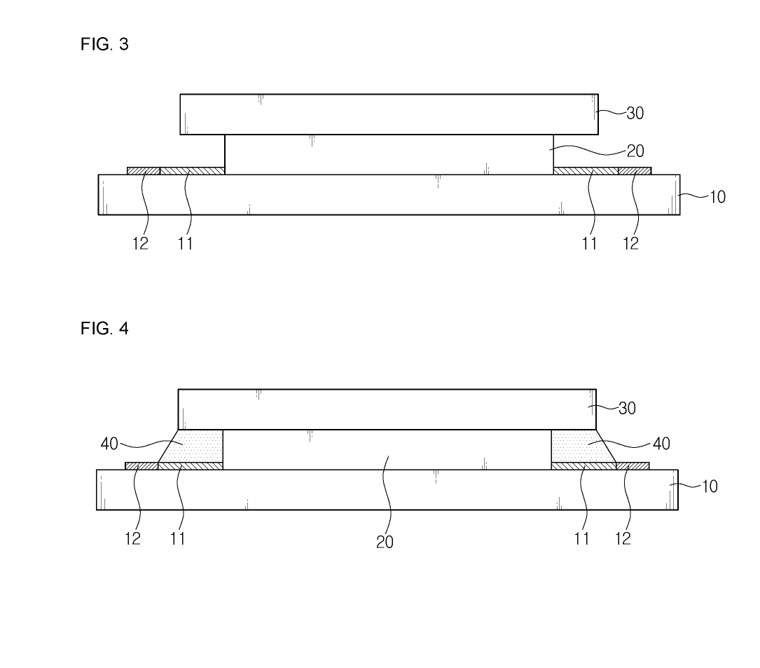

FIG. 3 is a cross-sectional view illustrating an electrophoretic display according to an embodiment of the present disclosure (before a sealant is applied);

FIG. 4 is a cross-sectional view illustrating an electrophoretic display according to an embodiment of the present disclosure (after a sealant is applied);

FIG. 5 is a detailed view illustrating a portion of an electrophoretic display according to an embodiment of the present disclosure; and

FIGS. 6 to 12 are views illustrating a method for manufacturing an electrophoretic display according to an embodiment of the present disclosure.

### DETAILED DESCRIPTION

Hereinafter, explanation will be made in detail on an electrophoretic display of the present disclosure and a manufacturing method thereof based on specific embodiments.

The following detailed description will include only the components necessary for those skilled in the art to understand the electrophoretic display and method for manufacturing the display according to the embodiments of the present disclosure, and explanation on other parts will be omitted so as not to obscure the essence of the present disclosure.

Furthermore, the terms and words used in this specification and the attached claims are not to be construed as being limited to general or lexical meanings, but are to be construed as meanings and concepts that are in line with the technical idea of the present disclosure so as to most appropriately describe the present disclosure.

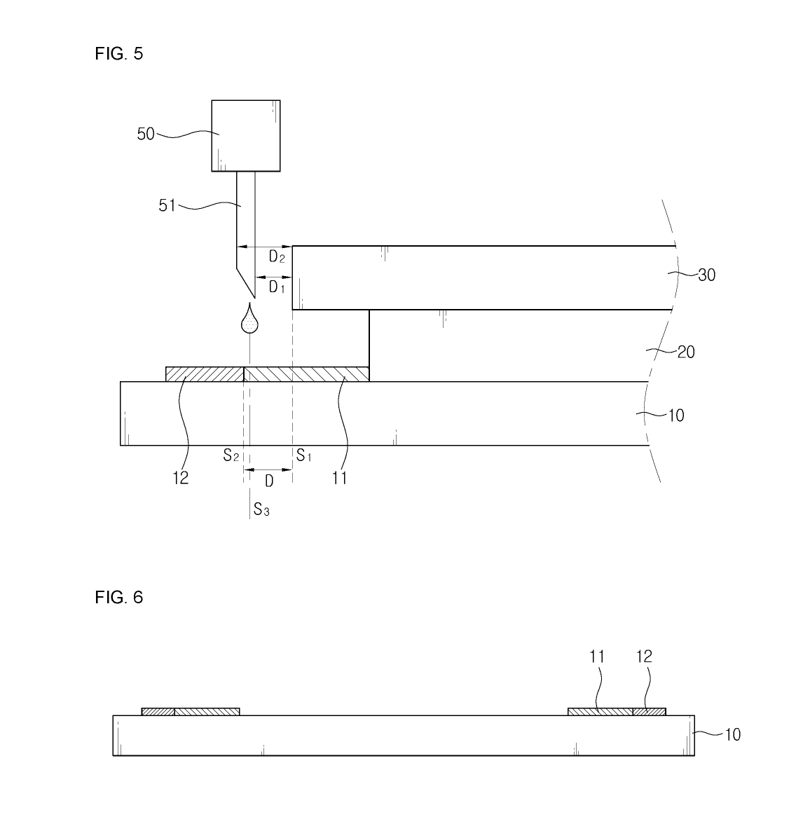

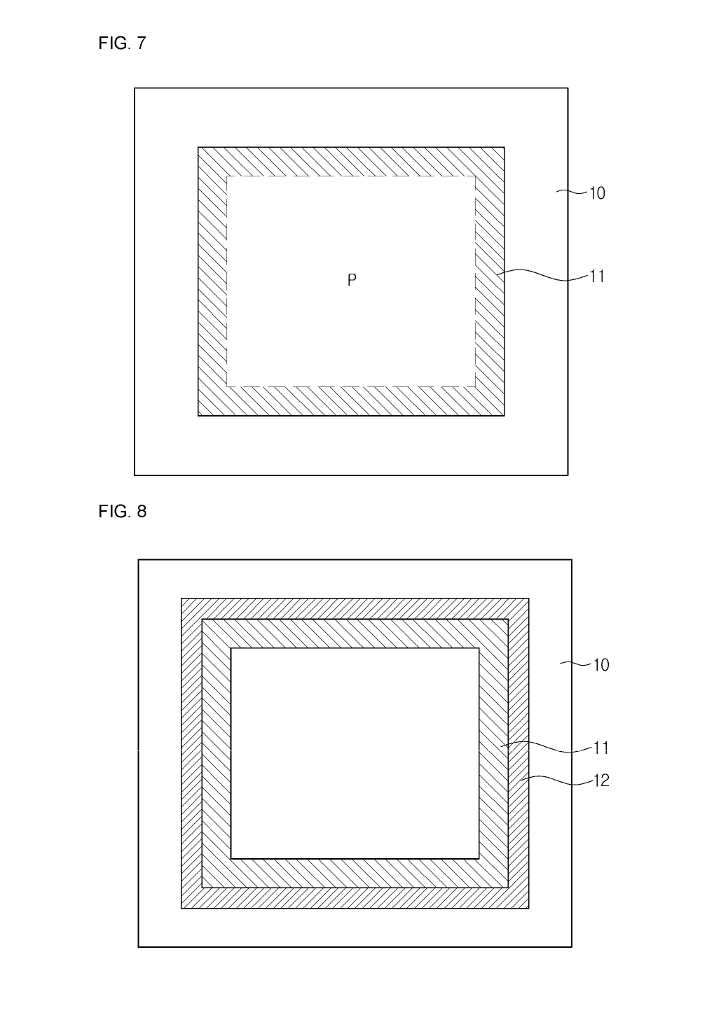

FIGS. 3 and 4 illustrate cross-sectional views of an electrophoretic display according to an embodiment of the present disclosure. FIG. 3 illustrates a state before a sealant is applied, while FIG. 4 illustrates a state after the sealant is applied.

As illustrated in FIG. 3, an electrophoretic display according to an embodiment of the present disclosure includes a substrate 10, an FPL 20 on top of the substrate 10, and a PS (Protect Sheet) 30 on top of the FPL.

The substrate 10 may be a glass substrate with a semiconductor layer deposited thereon, or a TFT substrate with a TFT formed thereon.

An FPL 20 (Front Plane Laminate) with electronic ink applied thereon is attached on top of the substrate 10, and the PS 30 (Protect Sheet) for protecting the FPL from moisture and scratches is attached on top of the FPL.

The substrate, FPL, and PS (Protect Sheet) are components well known to those skilled in the art, and thus detailed explanation will be omitted herein.

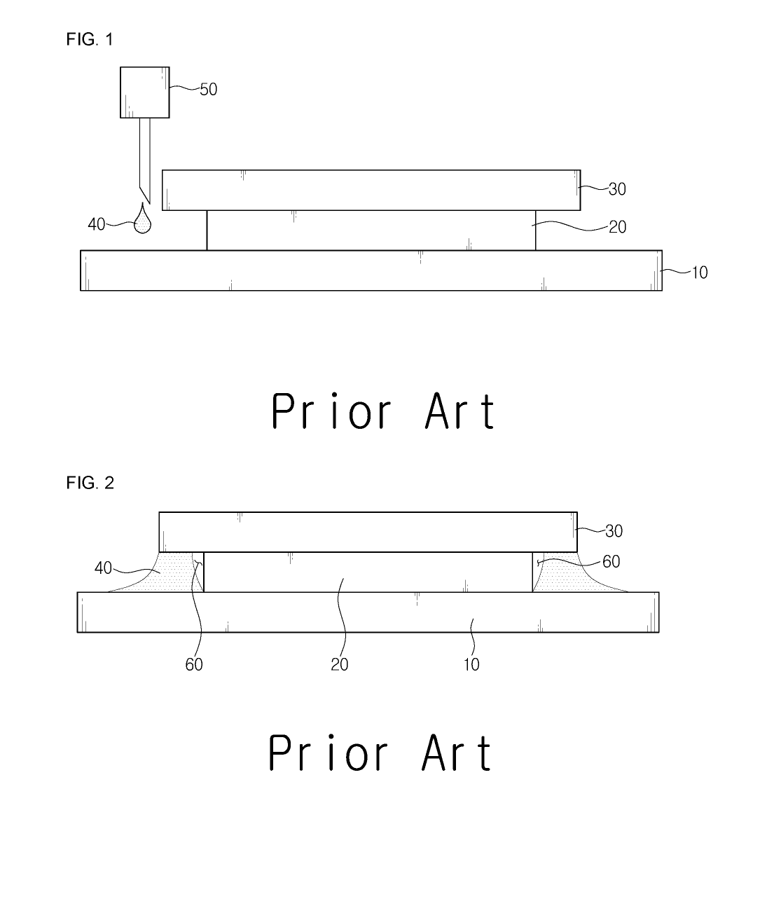

Unlike the conventional electrophoretic display illustrated in FIG. 1, the electrophoretic display according to the embodiment of the present disclosure is provided with an attractive force area 11 having the property of pulling the sealant and formed along the edge of the FPL.

Furthermore, a repulsive force area 12 having the property of pushing the sealant is formed outside the attractive force area on the substrate.

If the sealant is a hydrophilic sealant, the attractive force area 11 is a hydrophilic area, while the repulsive force area 12 is a hydrophobic area.

On the contrary, if the sealant is a hydrophobic sealant, the attractive force area 11 is a hydrophobic area, while the repulsive force area is a hydrophilic area.

The hydrophilic area may be formed by UV (ultraviolet) treating the substrate 10, or by applying a hydrophilic material on a top surface of the substrate. Furthermore, the hydrophobic area may be formed by applying a hydrophobic material on the top surface of the substrate. Detailed explanation will be made hereinafter.

Although it is illustrated in FIGS. 3 and 4 that the attractive force area 11 is not formed on the area where the FPL 20 is attached to the substrate 10, in other embodiments, the attractive force area 11 may be formed on a portion or entirety of the area where the FPL 20 is attached to the substrate 10.

When a sealant 40 is applied between the substrate 10 and the PS 30 along the edge of the FPL 20 of the electrophoretic display according to the embodiment of the present disclosure in order to seal the FPL 20, the attractive force area 11 pulls the sealant towards the FPL while the repulsive force area 12 pushes the sealant towards the FPL.

This improves the flowability of the sealant applied, extrudes out the air quickly from inside, and as illustrated in FIG. 4, the sealant 40 extrudes out the air from inside the electrophoretic display and is closely adhered to the FPL.

Furthermore, each of the attractive force area 11 and the repulsive force area 12 plays the role of keeping the sealant from oozing outside of the substrate before the sealant hardens.

For this purpose, it is desirable to form the area from where the sealant is applied up to the FPL as the attractive force area 11, and define the area outside of the attractive force area 12 as the repulsive force area 12.

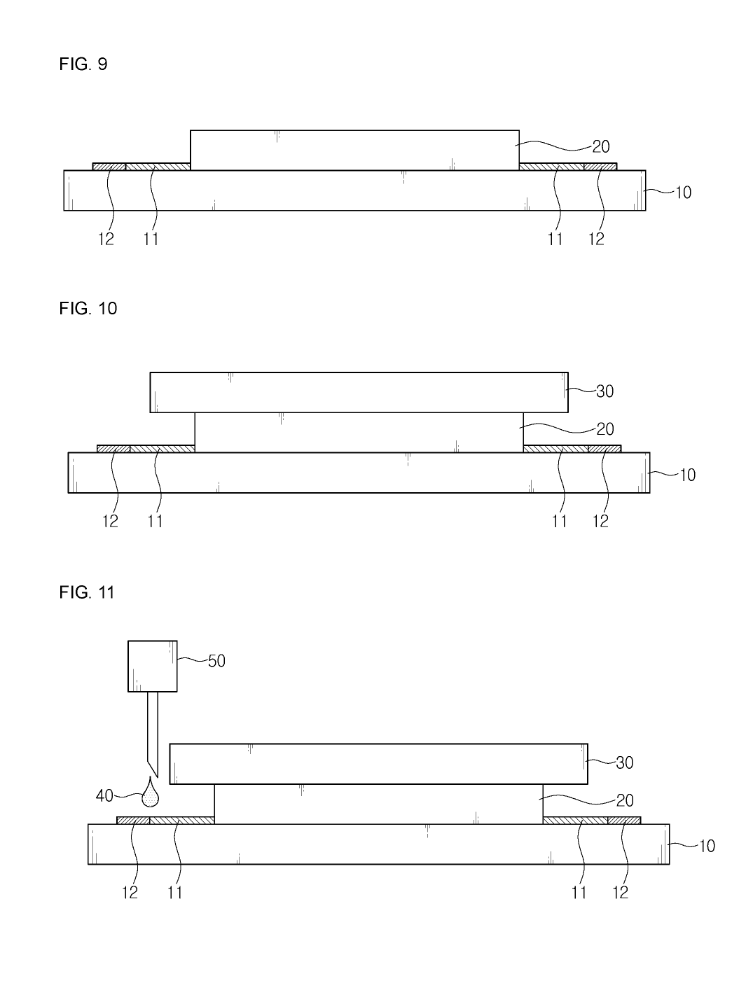

This will be explained in more detail hereinafter with reference to FIG. 5.

As illustrated in FIG. 5, the PS 30 (Protect Sheet) protrudes further beyond the FPL 20.

Therefore, when seen from above the substrate (that is, seen from the top), it is desirable that a boundary S2 between the attractive force area 11 and the repulsive force area 12 exists further outside on the substrate than an edge 51 of the PS 30 such that the boundary S2 exists further outside on the substrate than a position S3 where the sealant drops.

Furthermore, a needle 51 of a sealant application apparatus 50 is further outside on the substrate than the PS 30.

Therefore, it is desirable that a distance D from the PS 30 to the boundary S2 between the attractive force area 11 and repulsive force area 12 is the same as a distance D2 of a distance from the PS 30 to the sealant needle 51 and a thickness of the sealant needle 51 combined (D=D2) so that a force of pushing towards the FPL is applied to the sealant dropped on the substrate.

However, the boundary between the attractive force area and repulsive force area is not limited to the aforementioned range, and thus the distance D from the PS 30 to the boundary S2 between the attractive force area 11 and the repulsive force area 12 may be longer than the distance D1 from the PS 30 to the needle 51 but shorter than the distance D of the distance from the PS 30 to the sealant needle 51 and the thickness of the sealant needle 51 combined (D1<D<D2).

Otherwise, the distance D from the PS 30 to the boundary S2 between the attractive force material 11 and the repulsive force material 12 may be slightly longer than the distance D2 of the distance from the PS 30 to the sealant needle 51 and the thickness of the sealant needle 51 combined as long as it is within the range suitable for the repulsive force area to provide a repulsive force to the sealant being dropped on the substrate (D>D2).

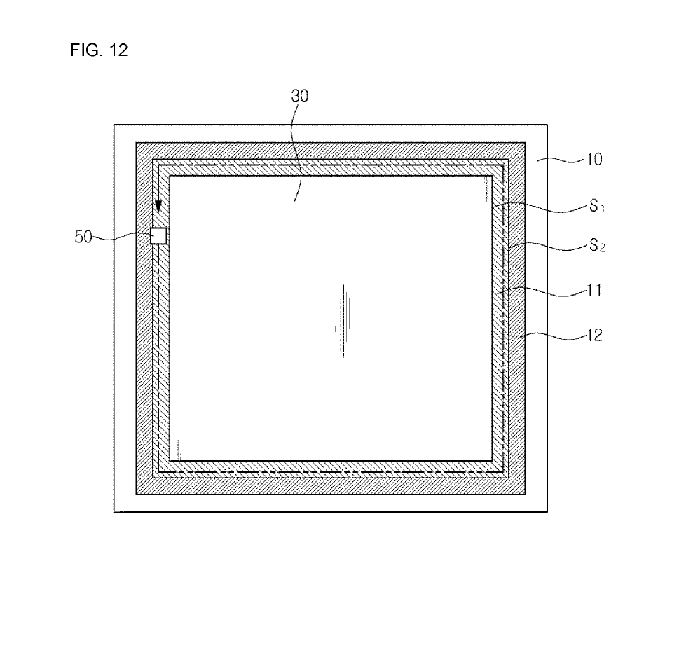

Hereinafter, a method for manufacturing an electrophoretic display according to an embodiment of the present disclosure will be explained with reference to FIGS. 6 to 12 attached hereto.

An attractive force area 11 and a repulsive force area 12 are formed on a top surface of a substrate 10 as illustrated in FIG. 6 in order to manufacture an electrophoretic display according to an embodiment of the present disclosure.

The attractive force area 11 is formed on an inner side on top of the substrate, and the repulsive force area 12 is formed on the outside of the attractive force area. Herein, the attractive force area is formed from an edge of an FPL that will be attached to the substrate at a subsequent step up to a certain area outside the FPL on top of the substrate.

More specifically, as illustrated in FIG. 7, the attractive force area 11 for pulling the sealant is formed on the outside of and along the boundary of the area P where the FPL is expected to be formed on top of the substrate 10. Otherwise, the attractive force area may be formed on an entirety or a portion of inside the area P where the FPL is expected to be formed.

Then, as illustrated in FIG. 8, the repulsive force area 12 for pushing the sealant is formed outside the area where the attractive force area has been applied.

When the sealant is a hydrophilic sealant, the attractive force area 11 is formed as a hydrophilic area, and the repulsive force area 12 is formed as a hydrophobic area.

On the contrary, when the sealant is a hydrophobic sealant, the attractive force area 11 is formed as a hydrophobic area, and the repulsive force area 12 is formed as a hydrophilic area.

The top surface of the substrate may be UV (ultraviolet) treated or a hydrophilic material may be applied on the top surface of the substrate in order to form the hydrophilic area. Forming a hydrophilic area by UV treating the top surface of the substrate also provides an effect of removing alien substance from the top surface of the substrate.

Furthermore, a hydrophobic material may be applied on the top surface of the substrate in order to form a hydrophobic area.

The order of forming the attractive force area and the repulsive force area may be the other way round.

Furthermore, although it is illustrated in FIG. 8 that the attractive force material 11 and the repulsive force material 12 protrude from the top surface of the substrate, there may be almost no height difference between the surface where the attractive force material or repulsive force material is applied and where neither of the material is applied.

Therefore, it is possible to form one of the attractive force area and repulsive force area on the entirety of the top surface of the substrate, and then form the other one of the attractive force area and repulsive force area only on a necessary portion.

More specifically, in the case of using a hydrophilic sealant, the entirety of the substrate may be UV treated or a hydrophilic material may be applied on the entirety of the substrate. Then, a hydrophobic material (for example, a Teflon material containing fluorine) may be applied only where the repulsive force area 12 needs to be formed (see FIG. 8) in a sputtering method through a mask.

As aforementioned, the boundary between the attractive force area and the repulsive force area formed as such should be further outside the substrate than the edge of the PS (Protect Sheet) that will be attached at a subsequent step.

More desirably, the boundary between the attractive force area and the repulsive force area may be in line with a motion path of the sealant needle applying the sealant, or slightly outside than the motion path.

After forming the attractive force area and repulsive force area on the top surface of the substrate in the aforementioned method, an FPL 20 is attached on the area P where the FPL is expected to be formed as illustrated in FIG. 9, and then a PS 30 is attached on top of the FPL as illustrated in FIG. 10. Herein, the FPL 20 and PS 30 may be attached in a lamination method.

After attaching both the FPL and PS on top of the substrate, a sealant 40 is applied between the substrate and the PS to prevent the FPL from being exposed to air (see FIG. 11).

More specifically, as illustrated in FIG. 12, the sealant application apparatus 50 applies the sealant on the space between the substrate 10 and PS 30 as it moves along the edge of the PS 30.

Once the sealant 40 drops on the top surface of the substrate, since the attractive force material 11 had been applied between the sealant and the substrate whereas the repulsive force material 12 had been applied on the outside portion of the substrate, a force of pulling towards the FPL acts on the sealant.

This force allows the sealant dropped on the top surface of the substrate to easily permeate towards the FPL, while inducing any air to be extruded towards outside.

Moreover, the sealant is also prevented from oozing outside the substrate until the sealant hardens.

While this disclosure includes specific embodiments of an electrophoretic display and a method for manufacturing the display, it will be apparent to one of ordinary skill in the art that various changes in form and details may be made in these embodiments without departing from the spirit and scope of the claims and their equivalents.

What is claimed is:

1. An electrophoretic display comprising:
a substrate;
an FPL on top of the substrate;
a PS (Protect Sheet) on top of the FPL; and
a sealant applied between the substrate and PS and along an edge of the FPL in order to seal the FPL;
wherein, on a top surface of the substrate, an attractive force area having a property of pulling the sealant is formed along the edge of the FPL and a repulsive force area having a property of pushing the sealant is formed outside the attractive force area.

2. The electrophoretic display of claim 1,
wherein, in response to the sealant being a hydrophilic sealant, the attractive force area is a hydrophilic area and the repulsive force area is a hydrophobic area, and in response to the sealant being a hydrophobic sealant, the attractive force area is a hydrophobic area and the repulsive force area is a hydrophilic area.

3. The electrophoretic display of claim 2,
wherein a hydrophilic material is applied on the hydrophilic area, and a hydrophobic material is applied on the hydrophobic area.

4. The electrophoretic display of claim 1,
wherein a boundary between the attractive force area and repulsive force area is outside the edge of the PS (Protect Sheet) when seen from the top.

5. The electrophoretic display of claim 2,
wherein a boundary between the attractive force area and repulsive force area is outside the edge of the PS (Protect Sheet) when seen from the top.

6. The electrophoretic display of claim 3,
wherein a boundary between the attractive force area and repulsive force area is outside the edge of the PS (Protect Sheet) when seen from the top.

7. The electrophoretic display of claim 1,
wherein the attractive force area is further formed under the FPL.

8. A method for manufacturing an electrophoretic display, the method comprising:
forming an attractive force area for pulling a sealant and a repulsive force area for pushing the sealant, on a top surface of a substrate;
attaching an FPL on top of the substrate;
attaching a PS (Protect Sheet) on top of the FPL; and
applying the sealant between the substrate and PS (Protect Sheet) along an edge of the PS (Protect Sheet) in order to seal the FPL;
wherein the attractive force area is formed outside the FPL on the top surface of the substrate, and the repulsive force area is formed outside the attractive force area on the top surface of the substrate.

9. The method of claim 8,
in response to the sealant being a hydrophilic sealant, forming the attractive force area as a hydrophilic area, and the repulsive force area as a hydrophobic area;
and in response to the sealant being a hydrophobic sealant, forming the attractive force area as a hydrophobic area, and the repulsive force area as a hydrophilic area.

10. The method of claim 9,
wherein the hydrophilic area is formed by UV (ultraviolet) treating the substrate.

11. The method of claim 9,
wherein the hydrophilic area is formed by applying a hydrophilic material on the top surface of the substrate, and the hydrophobic area is formed by applying a hydrophobic material on the top surface of the substrate.

12. The method of claim 8,
wherein the attractive force area and repulsive force area are formed such that a boundary between the attractive force area and repulsive force area is outside an edge of the PS (Protect Sheet) on the substrate.

13. The method of claim 9,
wherein the attractive force area and repulsive force area are formed such that a boundary between the attractive force area and repulsive force area is further outside than an edge of the PS (Protect Sheet) on the substrate.

14. The method of claim 10,
wherein the attractive force area and repulsive force area are formed such that a boundary between the attractive force area and repulsive force area is further outside than an edge of the PS (Protect Sheet) on the substrate.

15. The method of claim 11,
wherein the attractive force area and repulsive force area are formed such that a boundary between the attractive force area and repulsive force area is further outside than an edge of the PS (Protect Sheet) on the substrate.

16. The method of claim 12,
wherein the boundary between the attractive force area and repulsive force area is formed along a motion path of a sealant needle for applying the sealant.

17. The method of claim 13,
wherein the boundary between the attractive force area and repulsive force area is formed along a motion path of a sealant needle for applying the sealant.

18. The method of claim 14,
wherein the boundary between the attractive force area and repulsive force area is formed along a motion path of a sealant needle for applying the sealant.

19. The method of claim 15,
wherein the boundary between the attractive force area and repulsive force area is formed along a motion path of a sealant needle for applying the sealant.
